(19) United States
(12) Patent Application Publication
(10) Pub. No.: US 2009/0147270 A1
(43) Pub. Date: Jun. 11, 2009

(54) System and method for investigating and/or determining the condition or state of a ship's hull

(76) Inventor: Dirk Lehmann, Winsen (Luhe) (DE)

Correspondence Address: Friedrich Kueffner, Suite 910, 317 Madison Avenue, New York, NY, 10017, US

(21) Appl. No.: 12/082,236

(22) Filed: Apr. 9, 2008

(30) Foreign Application Priority Data
Dec. 7, 2007 (DE) 20 2007 017 116.1
Feb. 25, 2008 (EP) 08 003 401.0

(51) Int. Cl. G01B 11/30

(52) U.S. Cl. 356/600

(57) ABSTRACT

A system and a method for investigating and/or determining the condition or the state of a ship's hull, in particular its outer skin, for making it possible to select, in particular to lengthen, the docking time interval for ships depending on the condition or the state of the ship's hull. The outer skin is provided with a subdivision, in particular by means of at least one grid or network, which subdivision cooperates functionally with at least floating/submersible investigation/determination unit for investigating and/or for determining the condition or the state of the ship's hull.

### BACKGROUND OF THE INVENTION

1. Field of the Invention

The present invention relates to a system and a method for investigating and/or determining the condition or the state of a ship's hull.

2. Description of the Related Art

A certain time interval (for example, five years) is specified for ships and after this has elapsed, the ships must be docked for painting, inspection, repair, overhaul, maintenance or the like.

Such compulsory docking of ships after a fixedly predefined time interval has elapsed leads to high costs for the ship owner. Precisely for such economic reasons it is in the interest of the ship owner to extend these time intervals if possible, that is, to make them dependent on determining the state of the ship.

The possibility of docking depending on individual circumstances would also be desirable against the background that the waters to be navigated by ships have variable degrees of hardness and pollution and are aggressive to different extents, and consequently affect the ships, in particular the ship's hulls, to different degrees of intensity so that a fixed predefined painting, inspection, repair, overhaul or maintenance interval usually does not correspond with the actual condition or the actual state of a ship's hull.

### SUMMARY OF THE INVENTION

Starting from the disadvantages and inadequacies specified hereinbefore and acknowledging the outlined prior art, it is the object of the present invention to provide a system and a method of the type specified initially which allows the docking interval for ships to be selected, in particular to be extended, depending on the condition or the state of the ship's hull.

In order to specify the time or the time interval after which a ship such as a cruise ship, a cargo ship or a tanker should be brought into dock for painting, inspection, repair, overhaul, maintenance or similar, the present invention provides a system and a method for the, in particular, automatic investigation, determination and/or measurement of the hull condition or the hull state by means of a floating/submersible investigating/determining/measuring unit, in particular an underwater vehicle configured in the form of a floating measuring station.

The invention thus provides a system for investigating and/or for determining the condition or the state of a ship's hull, in particular its outer skin, where the system comprises a grid or network having a grid-square division or having individual units which cooperates functionally with at least one floating/submersible investigating/determining/measuring unit for investigating and/or determining the condition or the state of the outer skin of the ship's hull.

The grid or network is divided into individual units which are configured as surface configurations having the same shape, square, rectangular or another geometrical shape.

The units are provided with at least one ordering means or allocating means such as letters, numbers or letter/number combinations.

Furthermore, the grid or network with its individual units and ordering means or allocating means can be scanned, detected optically or detected electronically by means of the investigation/determination unit and converted into measured values.

According to a first embodiment, the outer skin of the ship's hull is provided with the grid or network. In this case, the subdivision of the outer skin can be implemented
by painting or
by locatable paint strips applied in particular under the paint of the outer skin.

A second embodiment provides that the grid or network is located in a measuring optical system of the investigating/determining/measuring unit.

A third embodiment provides that the grid or network is constructed visually between the ship's hull and the investigating/determining/measuring unit.

It is particularly advantageous if the grid or network is inserted into the measuring beam transmitted by the investigating/determining/measuring unit onto the ship's hull.

Alternatively to an embodiment as a manned and/or radio-controlled or manually controlled underwater vehicle, in particular a submersible or submarine, the investigation/determination unit can also be configured as a module that can be moved
along the ship's hull to be investigated and/or
at a distance, in particular uniformly at a distance, from the ship's hull to be investigated.

Regardless of the specific embodiment of the floating/submersible investigation/determination unit, according to the invention, a special ship skin configuration cooperates functionally, in particular electronically functionally, with the floating/submersible investigation/determination unit.

For the purpose of this cooperation, the investigation/determination unit is preferably provided with investigating/determining means for investigating and/or for determining, in particular for measuring, for example for the photo-optical, photographic or visual detection of the condition or the state, for example of the paint layer thickness and/or the roughness of the ship's hull, in particular the surface of the outer skin of the ship's hull.

These investigating/determining means or measuring devices are configured as
at least one device for locating the individual units on the ship's hull and/or
at least one device for scanning the surface of the outer skin in the individual units and/or
at least one device for measuring the paint layer thickness on the outer skin and/or the roughness of the outer skin.

The invention further relates to a method for investigating and/or for determining the condition or the state of a ship's hull or its outer skin, in particular by means of at least one grid or network which is provided with a subdivision, wherein said subdivision cooperates functionally with at least one floating/submersible investigating/determining/measuring unit for investigating and/or determining the condition or the state of the ship's hull or its outer skin.

A further method for investigating and/or for determining the condition or the state of a ship's hull or its outer skin consists in that a visual grid or network having a grid-square subdivision or individual units provided with ordering means or allocating means in the form of letters, numbers or letter/number combinations, extending in sections or entirely over the outer wall of the ship, is constructed as a pictorial presentation and visualisation on the outer skin of the ship's hull and directed onto the outer skin by a floating/submersible investigating/determining/measuring unit which can navigate parallel to the ship to be checked, so that the individual subdivisions or units are assigned to corresponding areas or sections of the outer skin by which means the condition or the state of the ship's hull or its outer skin is checked by photo-optical, photographic or visual detection.

In addition, the method provides that measured values obtained by means of the investigating/determining/measuring unit are evaluated and/or these measured values are used to calculate the time at which the ship should be brought into dock, in particular into a dry dock, for painting, inspection, repair, overhaul, maintenance or the like.

The present invention finally relates to the use of at least one floating/submersible investigation/determination unit, in particular at least one underwater vehicle, for example at least one submersible or submarine, for investigating and/or determining the condition or the state of the hull of a ship, for example, a cruise ship, a cargo vessel or a tanker, whose outer skin, in particular by means of at least one optically visible or invisible grid or network, has a subdivision into units, for example having the same shape.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a schematic perspective partial cross-sectional view of a first embodiment for a system according to the present invention, showing in accordance with the method according to the present invention comprising a fore portion of a ship whose outer skin is provided with a pattern having a framework in the form of plane squares, and with a floating/submersible underwater vehicle containing the measuring devices;

FIG. 2 is a schematic side view of a second embodiment for a system according to the present invention operating in accordance with the method according to the present invention, showing an investigation/determination unit which can be moved at a distance along the hull of a ship to be investigated, for example, a cruise ship, a cargo vessel or a tanker, wherein the ship's skin is provided with a pattern comprising a framework in the form of plane squares; and

FIG. 3 is a schematic view of a third embodiment for a system operating according to the method in accordance with the invention comprising a navigable investigating/determining/measuring unit, wherein the outer skin of a ship's hull is investigated using a visually constructed latticework in the form of grid squares.

### DETAILED DESCRIPTION OF THE INVENTION

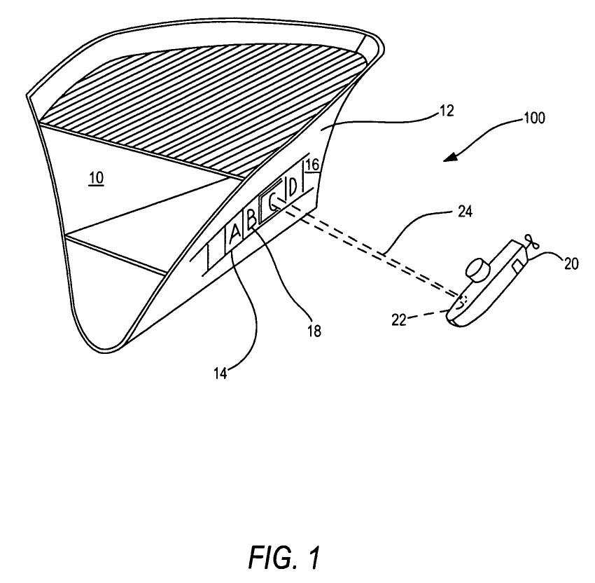

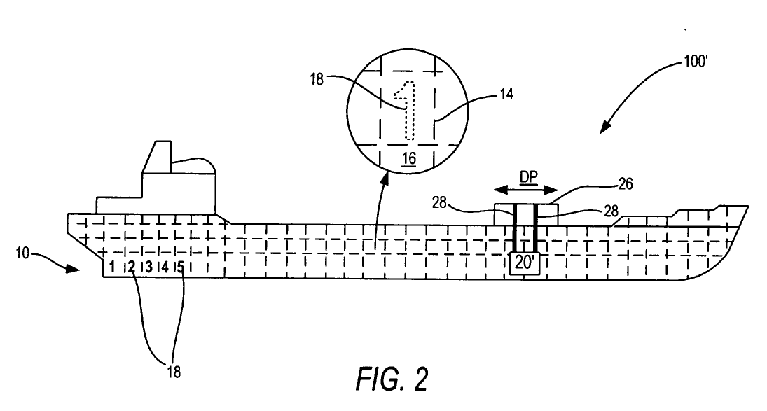

As can be seen from the diagram according to FIG. 1 and according to FIG. 2, the outer skin 12 of this ship's hull 10 is divided into individual grid squares 16 to implement the system 100, 100′ according to the invention for the automatic investigation and determination of the condition or the state of a ship's hull 10.

These grid squares 16 are formed by an optically detectable grid or network 14 applied to the ship's skin 12, for example by painting or by strips of paint applied underneath the paint of the ship's skin which can be located by means of a floating/submersible investigation/determination unit 20. It is also possible to apply a grid or network 14 which is not visible externally but can be located, on the side walls of the ship.

The grid square fields 16 can further be provided
with scannable letters A, B, C, D. . . . (see the first exemplary embodiment according to FIG. 1) and/or
with scannable numbers 1, 2, 3, 4, . . . (cf. second exemplary embodiment according to FIG. 2, in particular the enlarged circular diagram in FIG. 2)
   as ordering or allocating means 18 in order to ensure an ordered, planned and successive investigation and determination of the condition or state of the ship's hull 10.

In the first embodiment according to FIG. 1, the second part of the system 100, that is the floating/submersible investigation/determination unit 20, consists of a radio-controlled or manually controlled manned underwater vehicle in the form of a submarine 20 or ship configured as a floating measuring station.

The submarine 20 is, for example, provided with investigation/determination means 22 based on radar and/or for example based on ultrasound, i.e.
with devices for locating the individual grid squares 16 on the ship's hull 10,
with devices for scanning the surface of the ships' hull 12 in the individual grid squares 16,
with devices for measuring the layer thickness of the paint on the ship's skin 12
   and similar devices for measuring the condition of the state of the surface of the ship's skin 12.

The measured values obtained by means of the reflection (or at least partial reflection) of the detection/measurement beam 24 in the path to the ship's outer skin 12, based for example on radar or for example, on ultrasound, are evaluated or these measured values are used to calculate the time at which the ship must come into dry dock for the purpose of painting, inspection, repair, overhaul, maintenance or the like.

The surface condition or the surface state of the ship's skin 12 can be detected visually; in particular the paint layer thickness on the outer skin 12 and the roughness of the outer skin 12 are detected. In this case, the measuring devices are configured so that the surface of the ship's skin 12 can be detected photographically, photo-optically and/or by means of electronic means.

It is also feasible that within the scope of the present invention, the floating/submersible underwater vehicle 20 in the form of a floating measuring station starts out from a second ship and is received by this again after the investigation of the ship's hull 10, for example, for paint layer thickness and/or for roughness has been completed.

The second embodiment of the system 100′ in FIG. 2 is fundamentally based on the same method principle as the first exemplary embodiment of the system 100 according to FIG. 1; however a floating/submersible investigation/determination unit 20′ which can be moved along the ship's hull 10 to be investigated (⇄ reference numeral DP) is used to detect the condition and the state of the ship's hull.

In this case, the investigation/determination unit 20′ can be arranged, for example, on the rail of the ship to be investigated; in particular the investigation/determination unit 20′ can be lowered by means of cables 28 on the outer side 12 of the ship's hull 10 and then pulled up again after the investigation has been completed; in particular, the investigation/determination unit 20′ can be attached, for example to a mobile suspension device 26, possibly to a rod which can be moved along the ship's rail (⇄ reference character DP).

In this way, the outer skin 12 of the ship's hull 10 to be investigated can be scanned successively, i.e. in accordance with the sequence 1, 2, 3, 4, . . . of the ordering or allocating means 18, for paint layer thickness and roughness.

In a modification of the second exemplary embodiment according to FIG. 2 the investigation/determination unit 20′ is not located on the ship to be investigated itself, but at a distance, in particularly uniformly at a distance from the rail of a second ship, in particular an investigating ship.

By moving the investigation/determination unit 20′ along this second ship, it is possible to successively scan the outer skin 12 of the ship's hull 10 to be investigated for paint layer thickness and roughness.

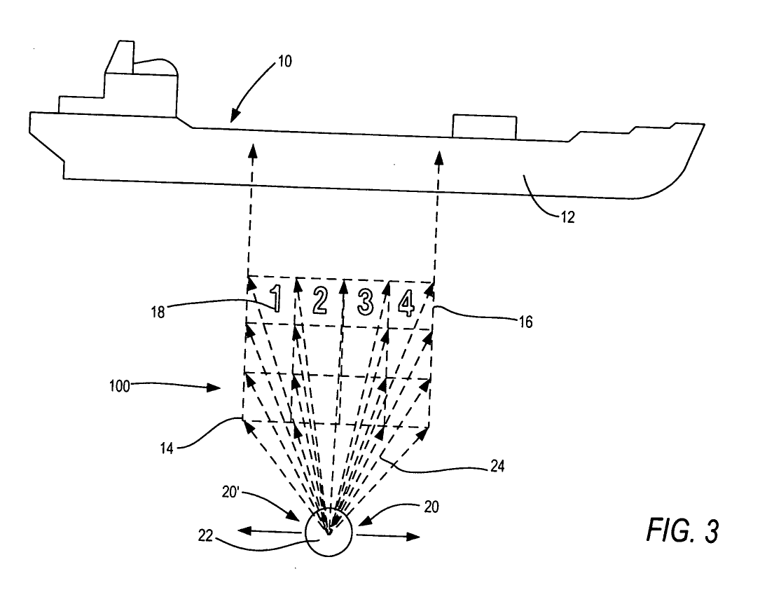

A further embodiment of the system according to the invention is shown in FIG. 3. In this embodiment the outer skin 12 of the ship's hull does not have a visible or invisible grid or network in the form of a unit 16 configured with grid squares.

In order to be able to specify the time or the time interval of the docking time of a ship for painting, inspection, repair, overhaul or maintenance, the system provides a floating/submersible investigating/determining/measuring unit in the form of a boat or submersible and a grid or network 14 which is arranged in a measuring optical system of the investigating/determining/measuring unit 20, 20′ or is constructed visually between the ship's hull 10 and the unit 20, 20′ (FIG. 3). Thus, the grid or network 14 can also be inserted into the measurement or observation beam transmitted by the unit 20, 20′ onto the ships' hull 10. In this case, the size of the grid or network 14 can cover the entire outer skin 12 of the ship's hull 10 but also only sections of the outer skin so that, due to the grid or network 12 co-migrating therefrom as the unit 20, 20′ moves parallel to the ship's hull 10, one section after the other of the outer skin can be detected and this can be checked so that by adding the measured section of the ship's hull, a complete monitoring image of the ship's hull or its outer skin 12 is obtained. In this embodiment the grid or network 14 is divided into individual units 16 forming grid squares which are provided with an ordering or allocating means 18 such as letters, numbers or combinations formed of letters and numbers. The use of a visually inserted grid or network 14 or the handling of a visual grid or network 14 has the advantage that the grid or network need not be applied to the outer skin 12 of the ship's hull 10 but can be used in conjunction with the investigating or determining means. Thus, the grid or network can be used, for example, in conjunction with measuring beams or in observation optics.

While specific embodiments of the invention have been shown and described in detail to illustrate the inventive principles, it will be understood that the invention may be embodied otherwise without departing from such principle.

I claim:

1. A system (100; 100′) for investigating and/or determining the condition or the state of a ship's hull (10), in particular its outer skin (12), the system comprising at least one grid or network (14), with a subdivision which cooperates functionally with at least one floating/submersible investigating/determining/measuring unit (20, 20′) for investigating and/or for determining the condition or the state of the ship's hull (10).

2. The system (100; 100′) for investigating and/or determining the condition or the state of a ship's hull (10), in particular its outer skin (12), according to claim 1, further comprising a grid or network (14) having a grid-square subdivision (16′) or having individual units (16), which cooperates functionally with at least one floating/submersible investigating/determining/measuring unit (20, 20′) for investigating and/or for determining the condition or the state of the outer skin (12) of the ship's hull (10).

3. The system according to claim 1, wherein the grid or network (14) is divided into individual units (16) which are configured as surface configurations having the same shape, square, rectangular or another geometrical shape.

4. The system according to claim 1, wherein the units (16) are provided with at least one ordering means or allocating means (18).

5. The system according to claim 1, wherein the allocating means (18) are letters, numbers or letter/number combinations.

6. The system according to claim 2, wherein the grid or network (14) with its individual units (16) and ordering means or allocating means (18) can be scanned, detected optically or detected electronically by means of the investigation/determination unit (20; 20′) and converted into measured values.

7. The system according to claim 1, wherein the outer skin (12) of the ship's hull (10) is provided with the grid or network (14).

8. The system according to claim 7, wherein the subdivision of the outer skin (12) is implemented
by painting or
by locatable paint strips applied in particular under the paint of the outer skin (12).

9. The system according to claim 1, wherein the grid or network (14) is located in a measuring optical system of the investigating/determining/measuring unit (20, 20′).

10. The system according to claim 1, wherein the grid or network (14) is constructed visually between the ship's hull (10) and the investigating/determining/measuring unit (20; 20′).

11. The system according to claim 9, wherein the grid or network (14) is inserted into a measuring beam transmitted by the investigating/determining/measuring unit (20; 20′) onto the ship's hull (10).

12. The system according to claim 1, wherein the investigation/determination/measuring unit (20 or 20′) is
configured as a manned and/or radio-controlled or manually controlled underwater vehicle, or
is movable along the ship's hull (10) to be investigated and/or at a distance, from the ship's hull (10) to be investigated.

13. The system according to claim 12, wherein the underwater vehicle is a submersible or submarine.

14. The system according to claim 12, wherein the distance is uniform.

15. The system according to claim 1, wherein the investigating/determining/measuring unit (20; 20′) is provided with investigating/determining means (22) or measuring devices for investigation and/or for determining for measuring for the photo-optical, photographic or visual detection of the condition or the state of the paint layer thickness and/or the roughness of the ship's hull (10) at the surface of the outer skin (12) of the ship's hull (10).

16. The system according to claim 5, the investigating/determining means (22) or measuring devices are configured
as at least one device for locating the individual units (16) on the ship's hull and/or
as at least one device for scanning the surface of the outer skin (12) in the individual units (16) and/or
as at least one device for measuring the paint layer thickness on the outer skin (12) and/or the roughness of the outer skin (12).

17. A method for investigating and/or determining the condition or the state of a ship's hull (10) or its outer skin (12), the method comprising providing at least one grid or network (14) having a subdivision, wherein said subdivision cooperates functionally with at least one floating/submersible investigating/determining/measuring unit (20, 20′) for investigation and/or for determining the condition or the state of the ship's hull (10) or its outer skin (12).

18. A method for investigating and/or determining the condition or the state of a ship's hull (10) or its outer skin (12), the method comprising constructing a visual grid or network (14) having a grid-square subdivision (16′) or individual units (16) provided with ordering means or allocating means (18) in the form of letters, numbers or letter/number combinations, extending in sections or entirely over the outer wall of the ship, as a pictorial presentation and visualization on the outer skin (12) of the ship's hull (10) and directed onto the outer skin (12) by a floating/submersible investigating/determining/ measuring unit (20, 20′) which is capable of navigating parallel to the ship to be checked, so that the individual subdivisions (16′) or units (16) are assigned to corresponding areas or sections of the outer skin (12) by which means the condition or the state of the ship's hull (10) or its outer skin (12) is checked by photo-optical, photographic or visual detection.

19. The method according to claim 14, comprising, obtaining measured values by means of the investigating/determining/measuring unit (20; 20′) are evaluating and/or using these measured values for calculating the time at which the ship should be brought into dock, in particular into a dry dock, for the purpose of painting, inspection, repair, overhaul, maintenance of the like.

20. A method of using at least one floating/submersible investigating/determining/measuring unit (20; 20′) for investigating and/or determining the condition or the state of a ship's hull (10) or its outer skin (12), in particular by means of a grid or network (14) provided with a subdivision into units (16), for example having the same shape, having ordering means or allocating means (18) in the form of letters, numbers or letter/number combinations.
